(19) United States
(12) Patent Application Publication
(10) Pub. No.: US 2008/0241312 A1
(43) Pub. Date: Oct. 2, 2008

(54) MODELING COMPOUND DISPLAY TOYS AND METHODS

(76) Inventor: Thomas P. Hamilton, Cranston, RI (US)

Correspondence Address: PERRY HOFFMAN & ASSOCIATES P.C., PO BOX 1649, DEERFIELD, IL, 60015, US

(21) Appl. No.: 11/694,251

(22) Filed: Mar. 30, 2007

(51) Int. Cl. B29C 45/00

(52) U.S. Cl. 425/573

(57) ABSTRACT

A modeling compound forming kit is disclosed including a front plate having rearwardly opening compartments, a center plate conjoining extrusion tubes for communicating modeling compound into the compartments of the front plate, and a back plate that may be received rearward of the center plate. The compartments may be provided independently such that compartments are achieved with barriers or partitions attached or as one or more separate elements that may be received in the assembly of the modeling compound display toy. The described methods of forming the modeling compounds in a toy provide the compartments for the display of the modeling compounds, and conjoining the extrusion tubes positionable for injection of the modeling compounds into one or more of the compartments. An injector tool is described for coupling with the extrusion tubes for injecting the modeling compound at the compartments. The back plate may be provided advantageously as a flexible material capable of being received onto the front plate. The front plate may also have a frontward frame for displaying the modeling compound at the front plate opposite the back plate. Further, the back plate may include a presentation element for displaying the modeling compound with the presentation element extending from the back plate for standing the back plate generally upright of a horizontal surface or a vertical surface. The plurality of extrusion tubes may each be provided as apertures, holes or openings for communicating modeling compounds into the compartments, possibly to providing injection sites for modeling compounds at various positions of the toy.

### FIELD OF THE INVENTION

The present invention relates generally to toys and more particularly to activity toys with which the child forms artworks and the like into a wide variety of items or artistic designs that may be framed to stand upright on a horizontal surface or to be hung upon the wall in the fashion of a picture.

### BACKGROUND OF THE INVENTION

Modeling compounds are well-known and commonly been used by children in their play activities. Apparatus and methods of various sophistication are known for forming modeling compound materials such as the popular PLAY-DOH™ formable material, colored plastic material, plasticene, modeling clay or the like. Such modeling compounds and the like are used by children to form a variety of shapes, articles or artwork. Modeling compounds may be molded with tools, by hand or by molds. Additionally, extrusion and template apparatus may be used. Children typically use such apparatus to fashion modeling compounds into a wide variety of desirable shapes, for example, animals, flowers, artwork or to form fanciful designs and the like.

Certain mechanisms have been employed for shaping, forming, or molding such modeling compounds are also known. U.S. Pat. No. 4,569,815 to Rentz et al. for Method and apparatus for simultaneously propelling and forming impressions with a flowable material, issued on Feb. 11, 1986 discloses a toy for extruding and molding various predetermined shapes of modeling compound or the like. In the Rentz et al. apparatus, a lever moves a piston to force the modeling compound either through an extrusion mold or into a mold cavity, so as to form the desired shapes.

It is also known to create certain forms of artworks utilizing modeling compounds. A device used to form such artworks is disclosed in U.S. Pat. No. 4,496,510 to Hanson et al. for Activity toy issued Jan. 29, 1985. With the Hanson et al. apparatus, the user may create needlecraft-like textured designs using a plastic material. Strands of the plastic material supported on a screen simulate the stands or nubs of needlecraft designs. An extruder is positioned adjacent the rear surface of the screen and moved along the screen so as to force plastic material through the screen mesh to create a needlecraft-like texture.

U.S. Pat. No. 5,427,528 to Anderson et al. for Activity toy and method of using to form artwork issued Jun. 27, 1995 is directed to a first plate upon which the plastic material is disposed so as to form the artwork and a transparent second plate disposable in laminar juxtaposition to the first plate so as to capture the artwork therebetween for enhancing the overall utility of crafts and artworks formed by hand, or by utilizing the Rentz et al., Hanson et al., or other such apparatus subject to deterioration and degradation, particularly that caused by handling and exposure to the elements, dust, dirt, moisture and the like.

While children have played with modeling compound for some time, modeling compounds can be somewhat resistant to deformation by children who do not always have sufficient strength to deform the modeling compound into desired forms. This has made it difficult to form modeling compound by unique impression, extrusion or molding of the modeling compound. Therefore it would be desirable to provide toys in the form of tools and the like as being more facilitative for use by children, especially those of early age, to assist in the creation of art forms.

There is a need for modeling compound display toys and methods and a kit therefore as disclosed including a front plate having rearwardly opening compartments, a center plate conjoining extrusion tubes for communicating modeling compound into the compartments of the front plate, and a back plate that may be received rearward of the center plate.

### SUMMARY OF THE INVENTION

In accordance with the present inventions, advantageous toys, methods and modeling compound forming kits provide a front plate having one or more rearwardly opening compartments thereon. A center plate conjoins a plurality of extrusion tubes thereon for communicating modeling compound into the compartments of the front plate. An injector tool is provided for coupling with at least one of the plurality of extrusion tubes for injecting the modeling compound at the one or more compartments. A back plate may be received rearward of the center plate. A method is described for forming modeling compounds in a toy by providing a plurality of compartments for the display of the modeling compounds, and conjoining a plurality of extrusion tubes with one or more of the plurality of extrusion tubes positionable for injection of the modeling compounds into one or more of the plurality of compartments.

Briefly summarized, the inventions relate to modeling compound display toys and methods including one or more compartments defined by partitions. An extrusion element is provided for being received at the one or more compartments, and a plurality of extrusion apertures, openings or tubes conjoined on the extrusion element in a described embodiment provide for communicating modeling compound into the compartments for displaying the modeling compound. The compartments may be provided independently such that compartments are achieved with barriers or partitions attached or as one or more separate elements that may be received in the assembly of the modeling compound display toy with plates. The modeling compounds are provided into the compartments through injection sites at various positions of the toy.

### BRIEF DESCRIPTION OF THE DRAWINGS

For the purpose of facilitating an understanding of the inventions, the accompanying drawings and description illustrate a preferred embodiment thereof, from which the inventions, structure, construction and operation, and many related advantages may be readily understood and appreciated.

FIG. 1A shows an exploded view of a preferred embodiment of a modeling compound display toy, illustrating a front plate having one or more rearwardly opening compartments having a themed character thereon, a center plate which conjoins a plurality of extrusion tubes thereon for communicating modeling compound into the compartments of the front plate, and a back plate for being received rearward of the center plate in an assembly in accordance with the present invention;

FIG. 1B is a cross-sectional view of an assembled configuration showing the front plate embodiment of FIG. 1A with the back plate received rearward of the center plate in accordance with the present invention;

FIG. 1C illustrates an alternate back plate having a presentation element, herein a stand or easel thereon for displaying the modeling compound with the presentation element extending from the back plate for standing the back plate generally upright in accordance with the present invention;

FIG. 2A shows an alternate front plate and frame in accordance with the present invention;

FIG. 2B is a cross-sectional view of an assembled configuration showing the front plate embodiment of FIG. 2A with a back plate received thereon;

FIG. 3A shows an injector tool for coupling with at least one of the plurality of extrusion tubes for injecting the modeling compound at the one or more compartments in accordance with the present invention;

FIG. 3B shows a plunger for use with the injector tool of FIG. 3A; and

FIG. 3C illustrates polybagged slugs of modeling compound for use with the injector tool of FIG. 3A in accordance with the present invention.

### DETAILED DESCRIPTION OF THE PREFERRED EMBODIMENTS

The following description is provided to enable those skilled in the art to make and use the described embodiments set forth in the best modes contemplated for carrying out the invention. Various modifications, however, will remain readily apparent to those skilled in the art. Any and all such modifications, equivalents, and alternatives are intended to fall within the spirit and scope of the present invention.

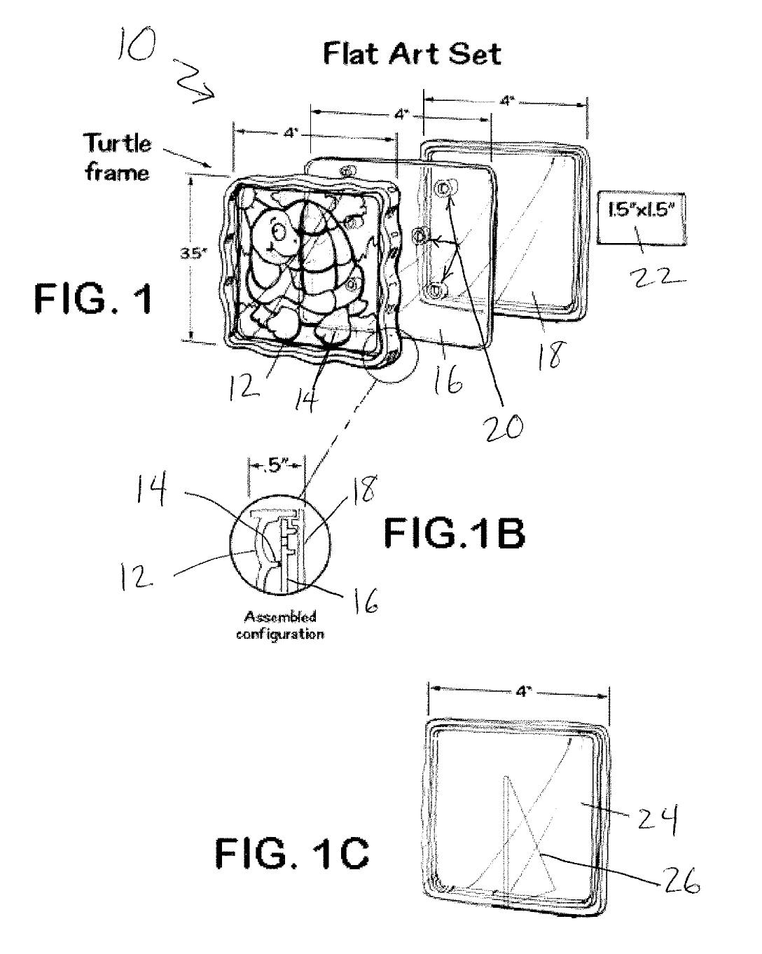

Referring now to the Figures, FIG. 1A shows an exploded view of an embodiment of the invention in which a modeling compound display toy 10 includes a front plate 12 having one or more rearwardly opening compartments 14. The front plate 12 has a themed character thereon. A center plate 16 provides an extrusion element which conjoins a plurality of extrusion tubes 20 thereon for communicating modeling compound into the compartments of the front plate 12, and a back plate 18 provides a backing material for being received rearward of the center plate 16 in an assembly. The plurality of extrusion tubes 20 may each be provided as apertures, holes or openings for communicating modeling compounds into the compartments 14. Further, the compartments 14 may be provided independent of front plate 12, instead of being provided on front plate 12, in an alternative embodiment in which the compartments 14 are achieved with the illustrated barriers or partitions attached either to the center plate 16 or possibly formed by a separate element which may be received between the front plate 12 and the center plate 16 of the assembly of the modeling compound display toy 10. Moreover in an alternative embodiment it would be further possible to provide injection sites for modeling compounds in the sides of the assembly or possibly even in the front thereof in the modeling compound display toy 10. The front plate 12 provided with a frame at is perimeter is particularly suited for displaying the modeling compound created in its interior areas. Accordingly the front plate 12 provides a clear or translucent surface using appropriate materials such as plastic, glass or the like allowing for viewing the modeling compounds through the front plate 12.

As shown the center plate 16 includes several extrusion tubes 20 for use with an injector tool 30 and plunger 32 described further below. The center plate 16 which conjoins the several extrusion tubes 20 in a planar arrangement is provided as a rigid plate preferably made of plastic although other materials may be contemplated. The back plate 18 may be provided in either a rigid or flexible plastic material or the like. When back plate 18 is provided a flexible plastic material it may be adapted to fit over or within the front plate 12. With reference to FIG. 1B the assembled configuration as shown provides the front plate 12 and back plate 18, and further in accordance with the present described embodiment the center plate 16 is sandwich there between. As will be appreciated the toy 10 is advantageously provided with multiple different themed frames associated with the front plate 12 and the rearward compartments 14.

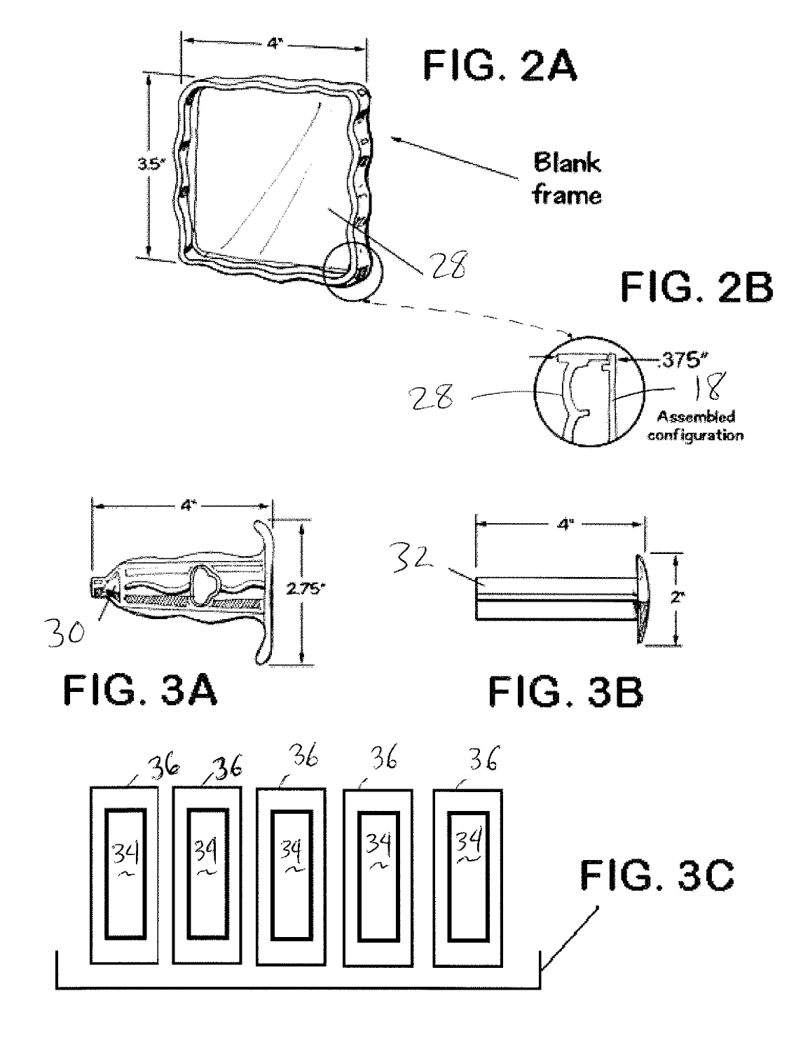

Thus through the use of the various different frames described modeling compound 34 provided in individual polyurethane bags as shown in FIG. 3C, for example maybe provided as five one ounce slugs of polybagged modeling compound 34. With reference to FIG. 2A the modeling compound 34 may be pressed or injected into either frame compartments 14 or the blank frames to create a displayable project. The alternate frame 28 may be used accordingly or alternatively the child may manually insert modeling compounds into the blank frame area, which is open for the child to create their own creation. With reference to FIG. 2B as discussed, the back plate 18 may also be applied to the alternate front plate 28 without the use of the center plate 16.

With reference to FIGS. 3A and 3B, as well as FIG. 1, the injector 30 is provided to be received the extrusion tubes 20 of the center plate 16. The modeling compound 34 provided in the several polyurethane bags 26 in the described kit may be used individually for insertion into the injector 30 and for application with the plunger 32 for injecting the modeling compound 34 into the compartments 14 of the front plate 12 through the extrusion tubes 20 of the center plate 16.

FIG. 1 provides and exemplary themed frame, provided as a turtle frame. The front plate 12 provided with a frame at is perimeter is particularly suited for displaying the modeling compound created in its interior areas. Through the use of the various modeling compounds 34 provided in individual polyurethane bags as shown in FIG. 3C, for example maybe provided as five one ounce slugs of polybagged modeling compound 34. With reference to FIG. 2A the modeling compound 34 may be pressed or injected into the turtle frame compartments 14 to create a displayable project in any number of possible designs and colors. The set also includes a back plate 18, wherein can be assembled with the center plate after the modeling compound has been injected into the compartments allowing for a permanent display of the finished artwork.

A modeling compound forming kit has been described and shown including the front plate 12 having its rearwardly opening compartments 14, with the center plate 16 facilitating the use of injected modeling compounds through extrusion tubes 20. The described methods of forming the modeling compounds in the toy 10 in the compartments 14 for display with the described presentation element allowing for displaying of the modeling compounds of the toy 10 standing generally upright of a horizontal surface or a vertical surface.

The set further includes a back plate which can be assembled with the center plate after modeling compound has been injected into the compartments. Accordingly, by injecting different colored modeling compound into the different compartments it is possible to make a colorful design on the image formed in the front frame and to then be displayed.

FIG. 1 provides and exemplary themed frame, provided as a turtle frame. As further shown in FIG. 1 a magnet 22 is provided for being affixed behind the rear plate 18 as a presentation element for displaying the modeling compound of the modeling compound forming toy 10 which advantageously the toy 10 to be secured vertically on a metal surface. Alternate presentation elements such as a hook or eyelet for securing the toy 10 to a wall may be contemplated. Additionally and alternate back plate 24 as shown in FIG. 1B provides a presentation element 26 as a stand or isle allowing the toy 10 to be orientated generally upright on a horizontal surface such as a table for a more permanent presentation.

As described the toy 10 may be provided with multiple different frames such as that of front plate 12, or alternately with reference to FIG. 2A an alternate front plate 28 is provided as a blank frame which may be used without the center plate 16 or extrusion tubes 20.

From the foregoing, it can be seen that there has been provided features for improved modeling compound forming toys and methods. While a particular embodiment of the present invention has been shown and described, it will be obvious to those skilled in the art that changes and modifications may be made without departing from the invention in its broader aspects. Therefore, the aim is to cover all such changes and modifications as fall within the true spirit and scope of the invention. The matter set forth in the foregoing description and accompanying drawings is offered by way of illustration only and not as a limitation. The actual scope of the invention is intended to be defined by subsequent claims when viewed in their proper perspective based on the prior art.

What is claimed is:

1. A modeling compound forming toy, comprising:
a first plate having one or more compartments thereon;
a second plate for being received on the first plate at the one or more compartments of the first plate; and
a plurality of extrusion tubes conjoined on the second plate for communicating modeling compound into the compartments for displaying the modeling compound at the first plate opposite the second plate.

2. A toy as recited in claim 1, comprising a third plate for being received at the extrusion tubes of the second plate with the first plate comprising a first portion, the second plate comprising a center portion, and the third plate comprising a back portion for enclosing the second plate between the first plate and the third plate.

3. A toy as recited in claim 2, wherein the third plate comprises a flexible material capable of being received onto the first plate.

4. A toy as recited in claim 2, wherein the first plate comprises a frontward frame for displaying the modeling compound of the modeling compound forming toy.

5. A toy as recited in claim 2, wherein the third plate comprises a presentation element for displaying the modeling compound of the modeling compound forming toy.

6. A toy as recited in claim 5, wherein the presentation element extends from the third plate for displaying the modeling compound of the modeling compound forming toy.

7. A toy as recited in claim 1, wherein each of the plurality of extrusion tubes are provided for receiving modeling compound for injection into the one or more compartments on the first plate.

8. A toy as recited in claim 1, wherein the one or more compartments comprise a plurality of rearwardly opening compartments on the first plate.

9. A toy as recited in claim 1, comprising an injector tool for coupling with at least one of the plurality of extrusion tubes for injecting the modeling compound at the one or more compartments.

10. A toy as recited in claim 9, wherein the injector tool comprises a plunger.

11. A method of forming modeling compounds in a toy, comprising:
providing a plurality of compartments for the display of the modeling compounds; and
conjoining a plurality of extrusion tubes with one or more of the plurality of extrusion tubes positionable for injection of the modeling compounds into one or more of the plurality of compartments.

12. A method as recited in claim 11, providing a plate for conjoining the plurality of extrusion tubes thereon.

13. A method as recited in claim 12, comprising a frame portion with the plurality of compartments opening rearwardly therefrom, providing a back portion for receiving the plate between the frame portion and the back portion for displaying the modeling compounds at the frame portion opposite the back portion.

14. A method as recited in claim 11, comprising a frame portion with the plurality of compartments opening rearwardly therefrom for displaying the modeling compounds at the frame portion.

15. A method as recited in claim 14, providing a back portion capable of being received at the compartments of the frame portion for displaying the modeling compounds at the frame portion opposite the back portion.

16. A method as recited in claim 11, comprising an injector tool for coupling with at least one of the plurality of extrusion tubes for injecting the modeling compounds into one or more of the plurality of compartments.

17. A modeling compound forming kit, comprising:
a front plate having one or more rearwardly opening compartments thereon;
a center plate conjoining a plurality of extrusion tubes thereon for communicating modeling compound into the compartments of the front plate;
a back plate for being received rearward of the center plate; and
an injector tool for coupling with at least one of the plurality of extrusion tubes for injecting the modeling compound at the one or more compartments.

18. A kit as recited in claim 17, wherein the back plate comprises a flexible material capable of being received onto the front plate.

19. A kit as recited in claim 17, wherein the front plate comprises a frontward frame for displaying the modeling compound at the front plate opposite the back plate.

20. A kit as recited in claim 17, wherein the back plate comprises a presentation element for displaying the modeling compound with the presentation element extending from the back plate for standing the back plate generally upright of a horizontal surface or a vertical surface.

21. A modeling compound forming toy, comprising:
a plurality of partitions defining one or more compartments;
an extrusion element for being received at the plurality of partitions; and
a plurality of apertures conjoined on the extrusion element for communicating modeling compound into the compartments for displaying the modeling compound at the plurality of partitions.

22. A toy as recited in claim 21, wherein the plurality of partitions comprise a frontward frame for displaying the modeling compound of the modeling compound forming toy.

23. A toy as recited in claim 21, wherein the one or more compartments comprise a plurality of compartments opening rearwardly of the frontward frame.

24. A toy as recited in claim 21, comprising a backing material capable of being received rearward of the plurality of partitions for enclosing the one or more compartments.

25. A toy as recited in claim 21, wherein the extrusion element comprises a plurality of extrusion tubes for receiving modeling compound for injection into the one or more compartments.
